(19) United States
(12) Patent Application Publication
(10) Pub. No.: US 2005/0041697 A1
(43) Pub. Date: Feb. 24, 2005

(54) Portable laser

(76) Inventors: Martin Seifert, West Simsbury, CT (US); Mansoor Alam, Rocky Hill, CT (US)

Correspondence Address: NUFERN, 7 AIRPORT PARK ROAD, EAST GRANBY, CT, 06026, US

(21) Appl. No.: 10/867,295

(22) Filed: Jun. 14, 2004

Related U.S. Application Data
(60) Provisional application No. 60/478,680, filed on Jun. 12, 2003.

(51) Int. Cl. H01S 3/30; H01S 3/10

(52) U.S. Cl. 372/6; 372/26

(57) ABSTRACT

Methods and apparatus for modifying a material with a laser light beam, such as, for example, a laser light beam provided by portable laser, such as, for example, a portable optical fiber laser.

### CROSS-REFERENCE TO RELATED APPLICATION

This application claims priority to provisional patent application 60/478,680, filed Jun. 12, 2003 and entitled “Portable Laser”, and which is herein incorporated by reference.

### FIELD OF THE INVENTION

The present invention relates to methods and apparatus for modifying, such as cutting, a material, and more particularly, to laser apparatus and methods for modifying a material.

### BACKGROUND OF THE INVENTION

Modifying a material, such as a metal, can include machining, cutting, ablating, heat treating, such as hardening or annealing, as well as other operations. For purposes of illustration, and without limitation, we describe cutting techniques for metal in the most detail. Cutting refers to processes that can include removal of metal (or alloy), or other material, from the workpiece by the application of mechanical or thermal energy. When the requirement calls for cutting of relatively thick sections at high speeds (e.g., emergency uses), the choice is usually limited to some type of thermal energy based cutting system. Popular thermal cutting systems involve the use of oxyfuel, air electric arc, gaseous thermal plasma or directed optical energy beam such as a laser. One can envisage several military and industrial scenarios that call for a portable metal cutting apparatus that can at least operate for short periods of time to cut metals/alloys (particularly mild steel) at high speeds.

Known thick section metal modification methods include: (a) oxyfuel techniques (b) air electric techniques, (c) gaseous thermal plasma techniques, and (d) laser beam techniques.

In oxyfuel cutting, a mixture of oxygen and fuel gas (hydrogen, acetylene, propane, butane, etc.) is used to preheat the steel to its “ignition” temperature (700-900° C.). A jet of pure oxygen is then directed onto the preheated area initiating an exothermic chemical reaction (formation of low melting temperature iron oxides). The oxygen jet blows away the oxides enabling the jet to pierce through the steel and continue to cut. FIG. 1 is a high quality photocopy illustrating one example of the oxyfuel cutting process. There are several nozzle designs that can significantly enhance the performance in terms of cut quality and cutting speed. In one practice, this technique is able to cut 0.5-3.0 inch thick mild steel plates at rates of 12-24 inch/minute. Equipment is generally light-weight and portable. One disadvantage from the portability perspective is the large oxygen consumption rate (several ft³/minute, depending on plate thickness and cutting speed) which can require large/heavy oxygen gas cylinders. Also, the cutting nozzle is in close proximity to the cutting surface and this result in the clogging of the nozzle.

In air arc cutting, an electric arc is generated in the air between the tip of an electrode (graphite or metal) and the workpiece. The arc melts the metal which is subsequently removed by high velocity air that streams down the electrode thus leaving a clean groove (cut). Typically, this process does not rely on oxidation. The width of the groove is determined largely by the electrode diameter. FIG. 2 is a high quality photocopy illustrating the electric arc cutting technique. The process is simple to apply, has a high metal removal rate (up to 6 ft/minute depending on the thickness), and the gouge profile can be controlled. Disadvantages include air jet induced molten metal ejection over large distances, and excessive noise due to high electric current (up to 2 kA) and high air pressure (80-100 psi). For steel cutting, a DC power supply can be used. In certain practices, power supply demands are as high as 12 kW (60 V, 200 A). The extremely high power demands and oxygen pressure needs, do not lend this technique to adapt to a portable system (power requirements mandate large power packs, and high oxygen pressures mandate bulky cylinders).

A gaseous plasma cutting system can comprise a power source with controls, water cooling system and a torch. The arc formed between the electrode and the workpiece ionizes the supply gas (plasma) which is constricted by a fine bore copper nozzle. This increases the temperature (in excess of 20,000° C.) and the velocity (approaching the speed of sound) of the plasma emanating from the nozzle. For cutting, the plasma gas flow is increased so that the deeply penetrating plasma jet cuts through the material and the molten material is removed in the efflux plasma. Typically, plasma cutting of mild steel includes one or more of the following: (a) nitrogen with carbon. dioxide shielding, (b) nitrogen-oxygen or air, and (c) argon-hydrogen or nitrogen-hydrogen. FIG. 3 illustrates a typical plasma cutting torch. The plasma technique is best suited to cut thin sections (up to 1.5 inch). Plasma can cut a 0.5 mm thick mild steel plate at the rate of 180 inch/minute. Major disadvantages include low electrical-to-thermal energy conversion efficiency (100 kW output needs over 200 kW input), inability to cut thicker gauge metals, and splash back that causes torch fouling. Like air arc cutting, plasma cutting needs very high power which does not lend itself well to portability.

### SUMMARY OF THE INVENTION

In one aspect, the present invention provides a portable laser apparatus for modifying a material with a laser light beam, comprising: an optical fiber laser for providing the laser light beam, where the optical fiber laser can include an optical fiber including a rare earth and at least one diode for providing pump light to the optical fiber; a portable power supply; and a servo element for dithering the laser light beam.

The servo can include a piezoelectric. The portable power supply can include at least one battery. The portable power supply can include a plurality of power supplies, where each of the power supplies can repeatedly provide power according to a duty cycle, and the duty cycles can be arranged such that the laser can provide continuous wave laser light. The portable laser apparatus can include a controller for controlling the servo such that subsequent to an initial modification of the material by the laser light beam the servo dithers the beam to increase the area of material modified. The initial modification can include piercing the material. Increasing the area of the material modified can include increasing the kerf of a cut in the material. The portable laser can include a temperature sensor, and the controller can perform the subsequent dithering responsive to the temperature sensor. The portable laser can include a gas supply for providing a flow of gas to the material. The controller can control the flow of gas so as to provide first and second flow rates that are different, with the controller being able to provide one of the flow rates subsequent to an initial modification of the material. The controller can provide one of the flow rates responsive to a temperature sensor.

In another aspect, the present invention provides a portable laser apparatus for modifying a material with a laser light beam, comprising: an optical fiber laser for: providing the laser light beam, where the optical fiber laser can include a length of fiber including a rare earth and at least one diode for providing pump light to the length of optical fiber; a portable power supply; and a controller, where the controller can be adapted to control the laser light beam so as to initiate modification of the material with a continuous wave laser beam and to subsequently pulse the laser beam so as to continue to modify the material.

The portable laser can include a temperature sensor in communication with the controller and the controller can provide the subsequent pulsing of the laser light beam responsive to the temperature sensor. The portable laser can include a gas supply for providing a flow of gas to the material. The controller can control the flow of gas for providing a first flow rate and providing a second flow rate that is different than the first flow rate. The portable laser can include a temperature sensor, and the controller can changes the flow rate from the first flow rate to the second flow rate responsive to the temperature sensor. The portable power supply can include a plurality of power supplies, where each of the power supplies can repeatedly provide power according to a duty cycle, and the duty cycles can be arranged such that the portable laser can provide a continuous wave laser light.

Practice of the invention can also include methods.

In one aspect, the invention provides a method of operating a laser to modify a material, comprising: a) initiating modification of the material with a continuous wave laser light beam; and b) subsequent to a) pulsing the laser beam while continuing to modify the material.

Initiating modification can include piercing the material, and continuing to modify the material can include continuing to pierce the material. The method can include sensing a temperature and b) can be performed responsive to the sensing of the temperature. Performing b) responsive to the sensing of the temperature can include performing b) responsive to sensing an increase in the temperature. The method can including providing a portable fiber laser having a power supply, where the portable fiber laser provides the laser light beam. A flow of selected gas can be provided to the material. Providing the flow of a selected gas can include providing a first flow rate of the selected gas and, subsequent to the initiation, providing a second flow rate that is different than the first flow rate. The laser light beam can be dithered.

In yet another practice, the invention provides a method of laser operation to modify a material, comprising: a) directing a laser light beam to the material to initiate modification of the material; and b) subsequent to a) dithering the beam to increase the area of material modified.

Initiating modification can include piercing the material, and performance of b) can include continuing to pierce the material. The method can include sensing a temperature and wherein b) is performed responsive to the sensing of the temperature. Performing b) responsive to the sensing of the temperature can include performing b) responsive to sensing an increase in the temperature. Increasing the area of the material modified can include increasing the kerf of a cut in the material. The method can include providing a flow of a selected gas to the material, including providing a first flow rate of the selected gas and subsequent to the initiation providing a second flow rate that is different than the first flow rate.

### BRIEF DESCRIPTION OF THE DRAWINGS

FIG. 1 is a high quality photocopy illustrating one example of the oxyfuel cutting process;

FIG. 2 is a high quality photocopy illustrating the electric arc cutting technique;

FIG. 3 illustrates a typical plasma cutting torch;

FIG. 4 is a high quality photocopy illustrating one prior art practice of laser cutting;

FIG. 5 schematically illustrates a fiber laser; and

FIG. 6 schematically illustrates one embodiment of the invention.

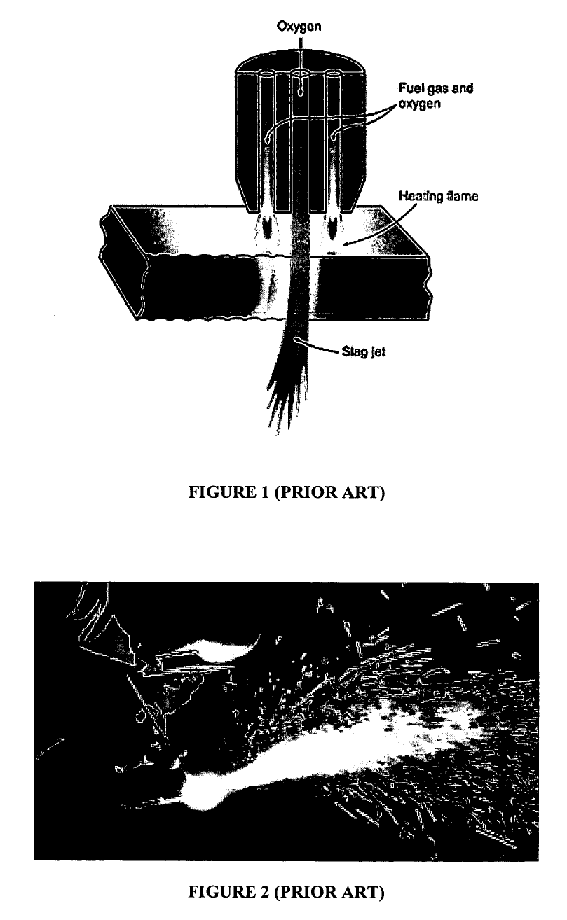

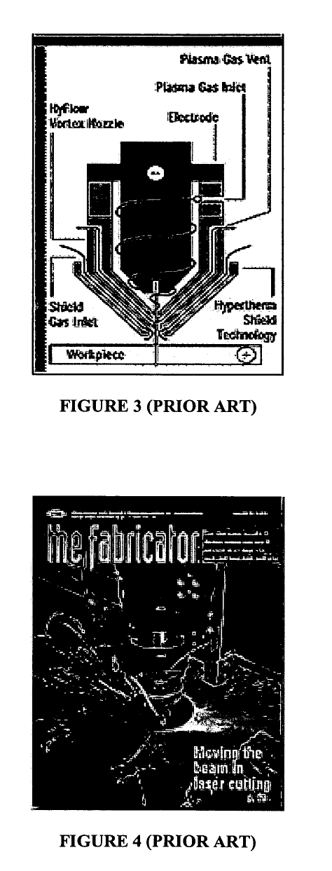

Not every component is labeled in every one of the foregoing FIGURES, nor is every component of each embodiment of the invention shown where illustration is not considered necessary to allow those of ordinary skill in the art to understand the invention. The FIGURES are schematic and not necessarily to scale.

When considered in conjunction with the foregoing FIGURES, further features of the invention will become apparent from the following detailed description of non-limiting embodiments of the invention.

### DETAILED DESCRIPTION

Among the many cutting techniques, the inventors consider laser cutting to be the most promising from the point of view of yielding an improved apparatus, such as a portable apparatus having a reduced weight or size. This assessment is based on relatively modest requirements of the input power supply unit and the gas consumption rate. Laser cutting can also afford the opportunity to provide the thermal energy directly to the site where it is needed. In other cutting systems thermal energy can be transferred to the cutting site via heavy reliance on conduction or convection or by both the mechanisms. Using suitable optics, the laser beam focal spot size can often be reduced to increase brightness (energy density), beam quality can often be improved (more power. accommodated in the fundamental mode), and working distance can often be increased. One or more of these factors can help contribute to higher cutting speed and decreased fouling of the laser delivery optics.

Cutting tools are preferably light weight so that they can be carried easily by a single person (or a party of two or three persons). It can also be desirable that these tools operate continuously for at least 2 minutes to cut through 0.5 inch thick mild steel plates at rates of, for example, at least 60 inch/minute. It can be advantageous that the tool be scalable to meet the more stringent cutting demands of the future. Another desirable feature of these tools is an increased working distance (separation between the energy source and the workpiece) to avoid problems associated with energy source fouling. Cut surface quality in terms of the kerf width and the heat-affected zone can also be important considerations. In some practices these considerations are secondary to having the ability to provide the cut.

Laser cutting can take advantage of the concentrated beam energy available from a laser source. In this thermal process, a focused laser beam heats the metal until it melts or vaporizes. FIG. 4 is a high quality photocopy illustrating one prior art practice of laser cutting. Laser cutting can often provide on or more of relatively straight cuts, the ability to cut a wide variety of metals/alloys including steels, and minimum warpage. Cutting speeds can be slow, such as when cutting thick sections (over 0.5 inch). Investment and/or maintenance costs can be high.

However, with gas assistance, cutting speeds can be increased. Typical assist gases include, but are not limited to, air, oxygen, nitrogen and argon. Oxygen is perhaps the most common assist gas when cutting ferrous alloys. When delivered coaxially through a nozzle, oxygen acts as a mechanical means of forcing the molten metal from the cut zone. It also acts as a cooling medium that reduces the heat affected zone (HAZ). The most important role of oxygen however, is the rapid oxidation of iron to oxides due to the exothermic reactions. Oxygen assisted cutting speeds far exceed cutting rates with other assist gases. With oxygen assistance, mild steel plates as thick as 2 inches can be cut effectively. A 6 kW oxygen assisted laser cutting system has been able to cut mild steel up to 3 inch thick. In general, 0.5 inch thick steel plates can be cut at speeds of 75 inch/minute while 1 inch thick steel plates can be cut at speeds of 24 inch/minute. The cutting speed seems to be limited by the removal of material from the cut zone. Oxygen supply requirements are also moderate (up to 1 ft³/minute) relative to the other methods.

Laser based material modification, such as cutting, has mushroomed because of the availability of very high energy densities and the ability to direct the beam. Because the beams can be highly collimated and can be focused to spot sizes of 0.2-0.3 mm, peak energy densities of 5-200 kW/mm² can be reached. The high energy density in conjunction with oxygen assistance provides high cutting rates.

Gas lasers and solid-state lasers are both known to be useful for cutting. CO₂ lasers, which emit at 10.6 μm, are very important. These lasers contain a mixture of gases in which CO₂ is the lasing medium, excited by an electric discharge between electrodes placed in the discharge tube. Large units can develop over 40 kW in continuous wave mode at 15% efficiency. Among the solid-state lasers, most important are Nd:YAG lasers which emit at 1.06 μm. These lasers can include small concentrations of neodymium (Nd) ions in yttrium aluminum garnet (YAG) pumped with high intensity white light from a xenon or krypton lamp. They can develop several kW in continuous wave mode, but the conversion efficiency is low, around 2%. Key advantages of CO₂ lasers over Nd:YAG lasers include better beam quality and focusability, higher cutting speed, ability to cut thicker sections, fewer safety issues, and lower set-up and operating costs for similar power levels. Key advantages of Nd:YAG lasers over CO₂ lasers include the ability to deliver the beam through fiber optics leading to simple beam alignment and delivery, higher absorbtivity of the laser beam (at least for iron and steel), simpler and inexpensive maintenance, and smaller size.

From the portability perspective, solid state lasers enjoy a significant advantage over gas lasers. A portable metal cutting system that can cut through 0.5 inch thick mild steel plates at rates of over 60 inch/minute, and that could operate continuously for 2 minutes is most likely to be based on some type of solid-state laser technology.

Solid state lasers (SSLs) use a solid material, such as, for example, a crystalline material, as the lasing medium and are usually optically pumped. Modern SSLs often use neodymium (Nd) doped materials such as Nd:YAG, Nd:YVO₄, Nd:Glass, and others. Continuous SSLs may use xenon or krypton arc lamps or other sources of intense broad spectrum light. However, the recent trend is towards the use of arrays of high power laser diodes to do the pumping. These can be designed to have a wavelength that matches an absorption band in neodymium (around 800 nm) making for very efficient excitation. The diode-pumped approaches are more efficient, resulting in lower power consumption and heat dissipation, compact size, higher reliability and lower maintenance.

Wall plug efficiency can vary from well under 1% for flash lamp and arc lamp pumped SSLs to 25% or more for those pumped with laser diodes. At higher pump powers, thermal issues cause the efficiency to decrease after a certain point. This decrease is power dependent, as well as resonator and pump assembly design dependent.

While much greater energy or power can generally be obtained from a given volume of a solid state lasing medium compared to a gas laser, it is not unlimited. The output power from an Nd:YAG rod increases with pump energy—but only up to the point where the active lasing medium is saturated (i.e. all the dopant ions are raised to the upper state). Beyond this point, no amount of extra pump energy will make any difference besides generating unwanted waste heat. Also, a lightly-doped crystal will reach the excited state more quickly, and will have a longer fluorescence period because the laser “chain reaction” is inhibited by a reduced population of contributing ions.

A useful material modification system is one that is one or more of (1) small, so as, for example, to be “man portable” (capable of being carried by one or more persons); (2) capable of high output power; (3) low cost; (4) efficient; and (5) reliable. Generally speaking, these attributes are generally not associated with lamp-pumped SSLs. However, in compact diode-pumped SSLs the diode array, laser crystal, and the integral thermoelectric cooler are contained in a laser head package allowing them to be mounted on an air cooled heat sink. These compact lasers can be further packaged into modules comprising of multiple lasers, with beam delivery and drive electronics. Their beams can then be combined to achieve the desired power. SSLs are therefore, eminently suitable for the current need. However, further size reduction and/or other advantages can be achieved by considering a fiber laser, which are included in a preferred embodiment of the invention.

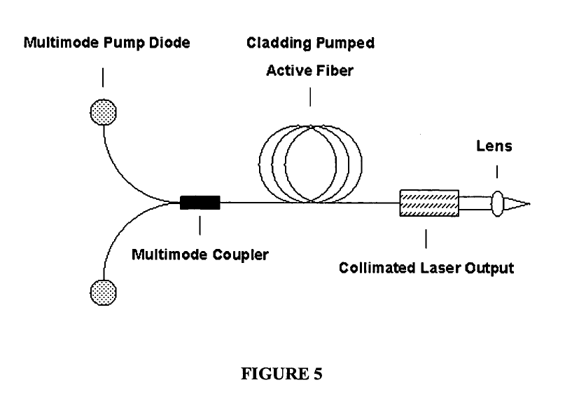

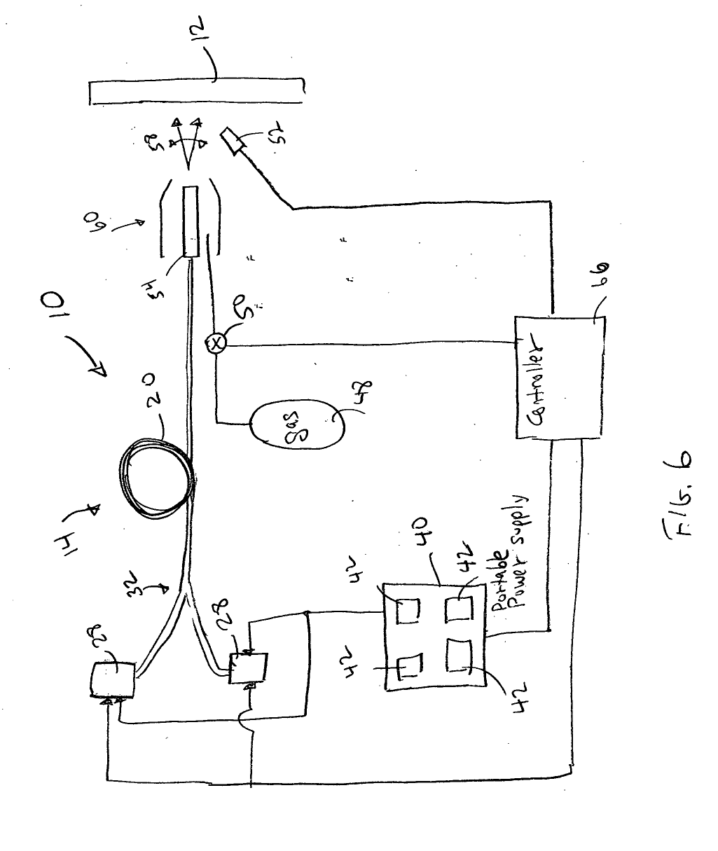

A fiber laser can comprise a pumped optical fiber amplifier. A diode, such as diode laser, can pump the optical fiber. The laser cavity can comprise a length of optical fiber (rare earth doped core surrounded by a large multi-layer cladding). Pump light, launched into the outer cladding (either from ends or side), is obtained from a series of high power multimode laser diodes coupled from all sides through special multimode couplers and is progressively absorbed by the doped core. FIG. 5 schematically illustrates a fiber laser. Such fiber lasers with cladding pump designs represent a new generation of diode-pumped configurations that are extremely efficient, have single mode output and may be operated with or without active cooling. It is said that fiber lasers will soon replace the lamp and diode pumped YAG lasers in most industrial applications due to enormous advantages in size, performance, reliability and ownership costs.

In various embodiments, fiber lasers can provide one or more of the following features:

(1) Because the lasing medium is also the guiding structure, fiber lasers can be less prone to alignment related problems. This allows the fiber laser to reach useful laser output levels more quickly, which may be of importance in military applications.

(2) Fiber laser sources can be brighter (high energy density) because of the small core size of the optical fiber. This can allow much higher cutting speeds.

(3) The beam quality of the fiber lasers can be better. This again would allow higher cutting speeds.

(4) In certain practices, the output power of the fiber lasers can scale directly with the input pump power. Multi-clad fiber geometry can allows for efficient pumping by high power laser diodes and the associated advantages.

(5) Fiber lasers can be scalable to higher output powers because of their geometry. Optical fiber has a very large surface area-to-volume ratio that relieves these lasers from detrimental thermal effects which are common in other SSLs having the same output power. As an example, a 50 m long double-clad fiber laser (DCFL) with a first cladding cross-section of 300×80 μm gives a surface area-to-volume ratio of ˜400/cm. On the contrary a bulk SSL with a 1 cm³ active element typically yields surface area-to-volume ratio of ˜10/cm.

Often, the output power of a single fiber laser cannot be extended beyond a certain point without compromising its advantages and flexibility. The maximum output power that may be generated can be, in certain circumstances, limited by one or more of the following: (1) fiber propagation loss; (2) amplified spontaneous emission; (3) thermal effects; (4) non-linear scattering processes; (5) surface damage to laser mirrors; and (6) optical breakdown of glass. This problem of scalability however, may be overcome by intelligent engineering. The output powers can be combined either spectrally, coherently or by some other mechanism to provide high output power. Coherent combination approaches can be relevant when the polarization state of the output beam is to be controlled. For metal cutting, polarization control is not always necessary and therefore, simpler approaches such as spectral beam combining and couplers may be used.

Fiber laser designs can, in certain instances, provide one or more of the following advantages: (a) efficiencies in excess of 15%, (b) absence of water cooling, (c) high beam quality, (d) ability to use small diameter fibers, (e) longer diode life, (f) minimal maintenance and adjustments, and (g) one quarter the size of most of today's industrial lasers. A 2 kW fiber laser weighing approximately 250 lbs has been deployed for metal cutting and welding purposes and is currently undergoing tests.

In one embodiment, the invention allows the deployment of a relatively light weight high power fiber laser for metal cutting. The invention can comprise laser diode sources, double-clad fibers (these are readily available), and portable power sources to drive the high power laser diodes for pumping the DCFLs. The outputs of several fiber lasers can be combined to achieve higher output power demand and smaller system packaging.

A portable high power fiber laser system according to the invention can comprise one or more of: (1) power source to energize the laser diode, (2) high power multimode laser diode to pump the fiber laser, (3) rare earth doped double clad optical fiber to serve as the lasing medium, (4) a mechanism to combine several fiber lasers to permit scaling to multi-kW output power, and (5) a nozzle to deliver oxygen coaxially with the output laser beam as a cutting aid. These are discussed next.

Prior experience with laser cutting suggests that cutting of 0.5 inch thick mild steel plates at rates of at least 60 inch/minute can be achieved with about 3 kW output Nd:YAG laser in conjunction with oxygen assistance. Therefore, in one aspect of the invention, there is provided a fiber laser that delivers up to 3 kW in continuous wave mode operation for up to 2 minutes. This corresponds to an energy requirement of 0.1 kW-h. Assuming a wall plug efficiency of 15%, a portable power source that can deliver up to 0.67 kW-h of energy can be suitable. One suitable power source can comprise rechargeable Lithium ion batteries for high energy applications. One type of battery delivers 1.5 kW in 3.5 minutes (7 discharges of 0.5 minute duration with 1 minute rest time in between discharges, equivalent to a 33% duty cycle). This gives total delivered energy of 0.0875 kW-h. However, since the duty cycle is only 33%, and the laser needs to be operated continuously for 2 minutes, the total energy delivered per battery is 0.0292 kW-h. This suggests a need for a total of 23 batteries (0.67/0.0292). Since each battery weighs 1.05 kg (height=20.8 cm, diameter=5.4 cm), the power source could contribute a total weight of 24 kg. With the small footprint, the weight of the power pack is compatible with a portable unit concept.

In one aspect, the invention can provide a fiber laser that will deliver up to 3 kW in continuous wave mode for up to 2 minutes. In one embodiment of the present invention, a laser system comprises six individual fiber lasers (each emitting 0.5 kW). Pump diodes can deliver maximum continuous output power for 2 minutes and lock their wavelength to the absorption peak of the fiber laser. This can involve pumping at a single wavelength (perhaps 915 nm for ytterbium as the rare earth in the broad absorption peak around 920 nm. Assuming a 65% efficiency for the conversion of pump optical power to the fiber output power, each 0.5 kW fiber laser can be effectively pumped from one side using a 0.75 kW pump. Six 0.75 kW laser diode pump arrays can be suitable. Such high power laser arrays are readily available. One such diode pump array can provide 0.75 kW of continuous wave optical pump energy in a compact, water cooled package (L=3.62 inch, W=0.625 inch, H=1.475 inch). These arrays deliver high power at 45-50% conversion efficiency and are highly reliable (10,000 hours lifetime). In general, the diode arrays run at 40° C. but can run hotter with higher efficiency which however, leads to lower life times. For this application, lifetime of the diodes is of secondary importance given a total run time of 2 minutes on any given occasion. Assuming a weight of about 0.5 kg per diode array, the diode arrays would contribute a total weight of about 3 kg. Once again with the small footprint, the weight and size of the diode arrays is compatible with a portable unit concept.

Beam delivery can be important in the successful and efficient use of high power laser diodes. Improving beam delivery to achieve output with high brightness, high power, and high optical quality is important. Fiber coupled high power laser diodes are available on the market. One produces 1 kW in 1 mm core fiber with an NA of 0.22. Optimizing the coupling efficiency between the diode array fiber and the fiber laser can include one or more of tapering of the diode coupled fiber, increasing the cladding diameter, or increasing the numerical aperture of the laser fiber.

Many high power devices have been designed incorporating rare-earth doped optical fibers as the lasing medium. A ytterbium (Yb) double clad (DC) fiber is an example of such a medium. This fiber offers several advantages such as high output powers, excellent conversion efficiencies over a broad range of wavelengths (975-1200 nm), a decreased effect from excited state absorption and concentration quenching, and the potential for a diffraction limited output. Although, single mode, Yb-doped, DC fibers lend themselves well to applications requiring compact lasers with diffraction-limited output, the scalability of output powers can be limited by amplified spontaneous emission and nonlinear processes such as stimulated Raman scattering (SRS) and stimulated Brillouin scattering (SBS). Fibers having low numerical aperture (NA) and large mode areas (LMA) are available to overcome these limitations. The low NA of the core can limits the capture of the spontaneous emission by the core while the large mode area can increases the threshold for SRS and SBS. Laser fibers are being used by a number of industrial and military entities for wide ranging applications. These fibers with core diameters, clad diameters, core NA and clad NA in the ranges of 10-30 μm, 180-400 μm, 0.06-0.08, and 0.31-0.45, respectively. It is estimated that, in one embodiment, about 50 m of such fiber will be used per laser in the form of a coil. This corresponds to a total fiber length of about 300 m in the laser system that would contribute practically no weight to the system.

The ability to combine multiple fiber inputs into a singular, efficient, high power and high brightness output with good mode quality can be important. The invention can use various approaches, such as, for example, the use of fused fiber couplers and spectral beam combining. In case of the fused coupler approach, individual DCFLs can be tapered and fused to a single multimode delivery fiber. In case of spectral beam combining, multiple fiber lasers can be multiplexed by causing them to operate at slightly different wavelengths, such that their beams can be combined on a grating. This technique can provide good beam quality and brightness and modest bandwidth and wavelength control of the individual sources.

As noted above, a gas, such as, for example, oxygen, can be supplied coaxially with the laser beam to the workpiece surface. Oxygen not only increases energy absorption but also provides heat as a result of exothermic oxidation that accelerates melting. Furthermore, oxides melt at a lower temperature and are blown away leading to higher cutting speed. Oxygen demand for laser cutting is relatively modest and can be as low as 0.25 ft³/minute. Such small amounts of oxygen can be stored in light weight bottles of a small footprint. The modest oxygen requirement does not jeopardize the system portability concept. In one practice of the invention, there is provided a beam delivery head that includes delivery of a focused laser beam with co-axial flow of oxygen.

Kerf thickness can be a positive attribute. Clearly the larger the cleared kerf the greater the clearances obtained in separating the scrap from the mother piece of steel. To accomplish the widening of the kerf one or more of the following technological innovations may need to be incorporated: (1) high frequency beam sweeping, (2) self modulated or bi-modal oxygen flow regimes, and (3) beam intensity modulation.

In one aspect, the invention comprises a power source, such as, for example, batteries, a fiber coupled diode having a power output of 4.5 KW, and 300 meters of rare earth doped (RED) fiber. The diodes can be used for 2 minute intervals, and then shut of for a selected period of time, then turned on again for 2 minutes.

In one practice of the invention, there is provided a fiber laser metal cutting system that weighs approximately 50 kg or less.

In another practice of the invention, there is provided an oxygen gas assisted man portable laser apparatus.

The invention can provide, according to one feature, a method and apparatus that allows a “man size” hole to be cut through plate steel using a portable laser apparatus

In one embodiment of the invention, it is expected that an operator, potentially under physical or emotional duress caused by his local environment will desire to egress or ingress through a steel wall without a conventional portal. It is further expected that with one free hand he will manipulate the output of this laser device in an appropriate sweep on or close to the surface of the steel plate to produce the cutout of his desired shape. Preferably, this action is simple so as to be manageable under potentially arduous and somewhat uncontrolled conditions, and result in a cut kerf adequate in size to prevent subsequent interlocking of the scrap from the mother plate.

In another embodiment of the invention, one or more of the magnitude, character, and duration of the heat of the material being modified (e.g., cut) is controlled. The heat can be controlled responsive to temperature feedback, such via the use of a pyrometer or other temperature sensing device. The temperature sensing device can be a spot temperature sensing device. The heat can thus be controlled automatically. Thus in one embodiment the user places a laser probe, such a laser fiber probe, adjacent to the target and initiates the cutting process. After initiation the temperature sensor would sense a temperature rise, and/or that the size of a region that exceeds certain a temperature, and at the appropriate temperature and/or size, a controller apply gas flow adapted to pierce the metal. A cut sustaining flow can then be applied, such as after adequate progress towards piercing the metal or an indication that the metal is indeed pierced. The application of heat can be reduced once the exothermic chemical reaction is initiated and sustained by the oxygen flow, such as by automatic control of the laser energy responsive to sensing of the material, such as of the temperature of the material. This can provide one or more benefits. For example, it can conserve battery life, reduce the size of the power supply needed, reduce the size of the laser, and prolong the service life of the laser source diodes. The active controller technology can re-pierce or re-initiate a cut in the event that the tool is inadvertently moved out of the active cut. This attribute of the laser and control system can allow the operator the freedom to multitask or otherwise pay less attention to the cutting process and put more of his attention to the other tasks that may be at hand.

Having a larger kerf thickness can be a positive attribute. The larger the cleared kerf the greater the clearances obtained in separating the scrap from the mother piece of steel. While lasers are naturally amenable to thin clean kerf cutting with very little oxygen flow the combination of the laser with a control can be used to make a more practical wide kerf. For example, in one aspect, the invention can comprise sweeping the laser beam, such as by dithering the beam. This attribute can be self-regulating based on pierce and cut performance as measured by the feedback mechanisms. While the pierce stage of the cut benefits from a highly concentrated narrow beam the wide kerf requirement does not. A piezo or other active servo element attached to the fiber output can dither or steer the beam to maximize the necessary preheat area for wide kerf propagation once the feedback mechanism confirms the pierce and has an established bum. For example, the fiber output of the laser could include a ferrule disposed about the fiber and a piezo electric element in mechanical communication with the fiber such that the output beam is moved.

In another embodiment, the invention comprises modulated or bi-modal oxygen flow regimes. A classical beginner's problem when using an oxy-fuel cutting torch is the premature application of the cutting oxygen stream, which either pops out the flame of the torch or cools the preheated zone thus pre-empting the cut. A man portable laser according to the invention can comprise oxygen assist. Active nozzle feedback can initiate a small, potentially laminar flow, piercing jet of oxygen at precisely the earliest possible moment at which the pierce can occur. As feedback occurs that indicates that the exothermic reaction is initiated the apparatus will introduce a much more vigorous oxygen flow to support a much larger burn, thus creating a significant kerf and/or ejecting the resulting slag.

In yet another embodiment, the invention can provide beam intensity modulation. Classical oxy-fuel cut thermodynamics are two stage, and include initiation and cutting. For the initiation phase the fuel is provided by the torch, and for the cutting phase the greatest fuel contribution is the steel itself. In one practice of the present invention, the laser beam is pulsed. The laser beam can be pulsed to initiate piercing, or alternatively or additionally, can be pulsed after piercing. The laser beam can be selectively pulsed. For example, the laser beam can otherwise be not pulsed, that is, pulsed after initiation but not during initiation, or pulsed during initiation and not immediately afterwards, or not again pulsed until a particular criteria is met. The laser can alternate between pulsed and non-pulsed operation.

FIG. 6 schematically illustrates an embodiment of a portable laser apparatus 10 for providing a laser light beam for modifying the material 12. The portable laser apparatus 10 includes many of the features described above. The portable laser apparatus 10 includes an optical fiber laser 14 including a length of optical fiber 20 that includes one or more rare earths (the rare earths include elements 57-71 on the periodic table). The fiber laser 14 includes at least one laser diode (two laser diodes 28 are shown in FIG. 6) that provide pump light to the length of optical fiber 20. The optical coupler 32 can be included for optically coupling the diodes 28 to the length of optical fiber 20. As is known in the art, the length of optical fiber 20 can include a laser resonator. A resonator can comprise, for example, a pair of gratings written in the length of optical fiber via selective application of actinic radiation, where the length of optical fiber can include sections of photosensitive fiber that include the gratings and that are spliced to the fiber including the rare earth. The optical fiber laser 14 can also include a seed oscillator (e.g., a laser diode) such that the length of optical fiber 20 amplifies light from the seed oscillator and need not include a laser resonator. Such configurations are well understood by one of ordinary skill in the art and cognizant of the present disclosure, and further elaboration is unnecessary.

The portable laser apparatus 10 can include the portable power supply 40, which in turn can include a plurality of individual power supplies (e.g., batteries) 42. The portable laser apparatus 10 can also include a gas supply 48 for providing a selected flow of gas to the material 12, such as via control of valve 50, a temperature sensor 52 (e.g., a pyrometer, fiber optic probe, etc.) for sensing the temperature of the material 12, and a servo element 54 (e.g., a piezoelectric) for dithering the laser light beam, as indicated by reference numeral 58. Typically, relative motion is provided between the material 12 and the laser light beam, such as by an operator moving the laser light beam relative to the material 12. A nozzle 60 can be provided, where the nozzle incorporates the servo (e.g., the piezoelectric), guides the flow of gas from the gas supply 48, and directs the laser light beam to the material 12. The nozzle 60 can also include the temperature sensor 52.

As indicated in FIG. 6, the controller 66 can control one or more of the portable power supply 40, the individual power supplies 42, the pump diodes 28, the gas supply 48 (e.g., by control of valve 50), and the servo 54 to practice the invention according to the various embodiments taught herein. The controller 66 can control one or more of the foregoing responsive to communication from the temperature sensor 52. Controllers and the operative arrangement and programming of controllers are all very well understood as a common aspect of modem industrial practice and further elaboration is not required. One of ordinary skill in the art, cognizant of the teachings herein, understands the selection and use of controllers to effectuate the functions described herein.

In the claims as well as in the specification above all transitional phrases such as “comprising”, “including”, “carrying”, “having”, “containing”, “involving” and the like are understood to be open-ended. Only the transitional phrases “consisting of”and “consisting essentially of” shall be closed or semi-closed transitional phrases, respectively, as set forth in the U.S. Patent Office Manual of Patent Examining Procedure §2111.03, 7th Edition, Revision.

1. A portable laser apparatus for modifying a material with a laser light beam, comprising:
an optical fiber laser for providing the laser light beam, said optical fiber laser including a length of optical fiber including a rare earth and at least one diode for providing pump light to the length of optical fiber;
a portable power supply; and
a servo element for dithering the laser light beam.

2. The portable laser apparatus of claim 1 wherein said servo includes a piezoelectric.

3. The portable laser apparatus of claim 1 wherein said portable power supply includes at least one battery.

4. The portable laser apparatus of claim 1 wherein said portable power supply includes a plurality of power supplies, where each of said power supplies can repeatedly provide power according to a duty cycle, said duty cycles being arranged such that the laser can provide continuous wave laser light.

5. The portable laser apparatus of claim 1 including a controller for controlling said servo such that subsequent to an initial modification of the material by the laser light beam said servo dithers the beam to increase the area of material modified.

6. The portable laser apparatus of claim 5 wherein said initial modification includes piercing the material.

7. The portable laser apparatus of claim 6 wherein increasing the area of material modified includes increasing the kerf of a cut in the material.

8. The portable laser of claim 5 including a temperature sensor, and wherein said controller performs said subsequent dithering responsive to said temperature sensor.

9. The portable laser of claim 1 including a gas supply for providing a flow of gas to the material.

10. The portable laser of claim 1 wherein said controller can control said flow of gas so as to provide first and second flow rates that are different, said controller being able to provide one of the flow rates subsequent to an initial modification of the material.

11. The portable laser of claim 10 including a temperature sensor, and wherein said controller provides one of said flow rates responsive to said temperature sensor.

12. A portable laser apparatus for modifying a material with a laser light beam, comprising:
an optical fiber laser for providing the laser light beam, said optical fiber laser including a length of fiber including a rare earth and at least one diode for providing pump light to the length of optical fiber;
a portable power supply; and
a controller, said controller being adapted to control the laser light beam so as to initiate modification of the material with a continuous wave laser beam and to subsequently pulse the laser beam so as to continue to modify the material.

13. The portable laser of claim 12 including a temperature sensor in communication with said controller and wherein said controller provides said subsequent pulsing of the laser light beam responsive to said temperature sensor.

14. The portable laser of claim 12 including a gas supply for providing a flow of gas to the material.

15. The portable laser of claim 14 wherein said controller can control said flow of gas for providing a first flow rate and providing a second flow rate that is different than said first flow rate.

16. The portable laser of claim 15 including a temperature sensor, and wherein said controller changes said flow rate from said first flow rate to said second flow rate responsive to said temperature sensor.

17. The portable laser apparatus of claim 12 wherein said portable power supply includes a plurality of power supplies, each of said power supplies for repeatedly providing power according to a duty cycle, said duty cycles being arranged such that the portable laser can provide a continuous wave laser light.

18. A method of operating a laser to modify a material, comprising:
a) initiating modification of the material with a continuous wave laser light beam; and
b) subsequent to a) pulsing the laser beam while continuing to modify the material.

19. The method of claim 18 wherein initiating modification includes piercing the material.

20. The method of claim 19 wherein continuing to modify the material includes continuing to pierce the material.

21. The method of claim 18 including sensing a temperature and wherein b) is performed responsive to the sensing of the temperature.

22. The method of claim 21 wherein performing b) responsive to the sensing of the temperature includes performing b) responsive to sensing an increase in the temperature.

23. The method of claim 18 including providing a portable fiber laser having a power supply, the portable fiber laser for providing the laser light beam.

24. The method of claim 18 including providing a flow of a selected gas to the material.

25. The method of claim 24 wherein providing a flow of a selected gas includes providing a first flow rate of said selected gas and, subsequent to the initiation, providing a second flow rate that is different than the first flow rate.

26. The method of claim 18 including dithering the laser light beam.

27. A method of laser operation to modify a material, comprising:
a) directing a laser light beam to the material to initiate modification of the material; and
b) subsequent to a) dithering the beam to increase the area of material modified.

28. The method of claim 27 wherein initiating modification includes piercing the material.

29. The method of claim 28 wherein b) includes continuing to pierce the material.

30. The method of claim 27 including sensing a temperature and wherein b) is performed responsive to the sensing of the temperature.

31. The method of claim 30 wherein performing b) responsive to the sensing of the temperature includes performing b) responsive to sensing an increase in the temperature.

32. The method of claim 27 wherein increasing the area of the material modified includes increasing the kerf of a cut in the material.

33. The method of claim 27 including providing a flow of a selected gas to the material, including providing a first flow rate of the selected gas and subsequent to the initiation providing a second flow rate that is different than the first flow rate.
